(19) United States
(12) Patent Application Publication
(10) Pub. No.: US 2021/0269285 A1
(43) Pub. Date: Sep. 2, 2021

(54) CRANE WITH AN ANTI-COLLISION DEVICE AND METHOD FOR INSTALLING SUCH AN ANTI-COLLISION DEVICE

(71) Applicant: Philip IRLE, Tübingen (DE)

(72) Inventor: Philip IRLE, Tübingen (DE)

(21) Appl. No.: 17/325,793

(22) Filed: May 20, 2021

Related U.S. Application Data
(63) Continuation of application No. PCT/EP2019/081180, filed on Nov. 13, 2019.

(30) Foreign Application Priority Data
Nov. 20, 2018 (DE) 10 2018 129 227.9

(51) Int. Cl. B66C 15/04; G01S 19/51; B66C 23/94

(52) U.S. Cl. CPC B66C 15/045; B66C 2700/082; B66C 23/94; G01S 19/51

(57) ABSTRACT

The invention relates to a method for installing an anti-collision device of a crane which has a boom that can be rotated about an upright rotational axis of the crane. A crane position and an orientation of the crane, in particular of the boom, are determined, wherein the crane position is automatically determined by means of a satellite navigation module on the crane and is provided to the anti-collision device in the form of global coordinates, and the orientation of the crane is automatically determined by means of an orientation sensor system attached to the crane and is provided to the anti-collision device in the form of a direction in the global coordinate system.

### CROSS-REFERENCE TO RELATED APPLICATIONS

This application is a continuation of International Patent Application Number PCT/EP2019/081180 filed Nov. 13, 2019, which claims priority to German Patent Application Number DE 10 2018 129 227.9 filed Nov. 20, 2018, the contents of which are incorporated herein by reference in their entireties.

### BACKGROUND

The present invention relates to a crane having an anti-collision device that warns of crane movements that may lead to collisions and/or that suppresses such crane movements leading to possible collisions. The invention further relates to a method for installing such an anti-collision device of a crane that has a boom that is rotatable about an upright crane axis, in which method a crane position and a crane orientation, in particular a boom orientation, are determined.

In cranes such as revolving tower cranes, crane movements that could lead to collisions have to be suppressed for safety reasons. On the one hand, with solid obstacles such as building perimeters or building fronts, the work region of the crane generally has to be restricted so that the boom or the crane hook having a load suspended thereon cannot be traveled against the obstacle. A corresponding work region restriction can, for example, include a restriction of the rotation region about the upright crane axis and/or a restriction of the travel distance of the trolley in a specific range of angles of rotation or also other movement restrictions.

On the other hand, it is also necessary with a plurality of cranes at one construction site to restrict the work region of a crane so-to-say dynamically in dependence on the respective current position of another crane. A general fixed restriction of the work range of the cranes in the aforesaid sense is not possible here since then the plurality of cranes could no longer work efficiently. If a boom of one crane is rotated toward the other crane, this is per se—for example—not yet a problem as long as the boom of the other crane does not also rotate into the corresponding region.

To be able to suppress such crane movements that may lead to possible collisions or at least to be able to warn a crane operator in good time, it is necessary that the anti-collision device is aware of the crane position and the boom orientation relative to the potential obstacles—either in the form of a fixed building or of a movable crane—or of the distance of the crane and its boom therefrom to be able to disable the crane movements dangerously reducing the distance or to be able to warn a crane operator in good time in advance.

Such an anti-collision device is described, for example, by document DE 24 41 785 A1 that represents the distances of the crane booms for the detection of these distances of the crane booms of a plurality of cranes from one another as vectors and determines the distance between the boom tips or partial boom pieces projected onto the horizontal from the difference of the vectors from one another.

An anti-collision device for cranes is further known from document EP 18 94 882 B1 that determines movement vectors in a similar manner per se, but does not determine them as actual values, but estimates them in a predictive manner to be able to intervene in movements at risk of collision at an early time.

The installation of the anti-collision devices of such cranes has previously been relatively laborious and prone to error if work is not carried out with the required care. In this process, the distance of the cranes from one another, more precisely the spacing of the crane centers, for example in the form of the tower tips of revolving tower cranes, is typically determined by means of laser measuring units. The orientation of the cranes with respect to one another, in particular the orientation of the booms with respect to one another additionally has to be determined, which typically takes place manually in that the cranes are manually moved into a specific relative position. The corresponding values are then taken over by the sensor of the anti-collision system. A considerable installation effort hereby results overall. In addition, safety-related errors can result when the measurements or the manual orientation determination are not carefully carried out by an experienced workman.

### SUMMARY

Starting from this, it is the underlying object of the present invention to provide an improved crane having an anti-collision device and an improved method of installing such an anti-collision device that avoid the disadvantages of the prior art and further develop the latter in an advantageous manner. A less error-prone installation of the anti-collision device of a crane with a reduced time effort should in particular be achieved.

In accordance with the invention, the named object is achieved by a method in accordance with claim 1 and by a crane in accordance with claim 7. Preferred embodiments of the invention are the subject of the dependent claims.

It is therefore proposed to provide the crane position and crane orientation to the anti-collision device in an automated manner with the aid of satellite navigation and an additional orientation sensor system to avoid a manual distance measurement wherever possible. In accordance with the invention, a satellite navigation module is provided at the crane with whose aid the crane position is automatically determined and is provided to the anti-collision device in the form of global coordinates. The orientation of the crane is automatically determined by means of an orientation sensor system arranged at the crane and is provided to the anti-collision device in the form of a direction in the global coordinate system. The provision of the position data and orientation data can take place fully automatically and can be directly read by the anti-collision device. Alternatively or additionally, the data can also be displayed to the crane operator on a display to provide the crane operator or a setup worker with the possibility of checking and optionally correcting before the displayed data are then provided in a semi-automated manner to the anti-collision system by acknowledgment.

Said orientation sensor system for determining the orientation of the crane boom can generally have different properties. A compass can, for example, be attached to the crane boom to determine its orientation in the global coordinate system, with said compass advantageously being able to be designed as electrical and/or being able to provide an electric signal that reproduces the orientation.

In an advantageous further development of the invention, however, the navigation module itself can also be used to determine the orientation of the crane boom, which appears counterproductive at first glance since a satellite navigation module itself can only determine a position and not an orientation. To resolve this contradiction, in an advantageous further development of the invention, the satellite navigation module can be attached to the boom or to a counterboom of the crane or to another crane element such as its ballast spaced apart from the crane axis of rotation so that said navigation module travels over an arc around the crane axis of rotation on the rotation of the crane. The orientation sensor system can determine the center of the circular path from the resulting circular path and the resulting series or sequence of position data to determine the orientation of the boom from the then known pivot point and the respective current position of the navigation module.

The orientation can, for example, be calculated by taking over the northernmost circular path point, with a slewing gear sensor associated with the slewing gear of the crane, for example, being able to be correspondingly calibrated when said northernmost circular path point is traveled through or reached to then always be able to know or take account of the respective orientation of the crane boom using the signal of the slewing gear sensor.

To be able to determine the circular path center and in turn derived from this the crane orientation from said circular path of the satellite navigation module, statistical or optimization processes known per se can be used. For example, the position data representing the circular path can be evaluated with the aid of a least square method and the circular path center and the corresponding crane orientation can be calculated.

Alternatively or additionally, the crane orientation can also be determined with the aid of two or more satellite navigation modules that can be attached spaced apart from one another, for example at the boom of the crane or at the boom and counterboom of the crane or at the crane axis of rotation and a point spaced apart therefrom at the boom or counterboom. If, for example, two satellite navigation modules are attached to the tip of the boom and to the rear side end of the counterboom, the crane or boom orientation that results as a straight line or a connection line through the two positions of the two navigation modules can be determined from the two positions of the navigation modules determined with satellite support.

Alternatively or additionally to the determination of the crane position and orientation by satellite navigation and optionally by an additional orientation sensor system, the installation of the anti-collision device can also be considerably simplified in accordance with a further aspect of the present invention in that the crane position is automatically provided to the anti-collision device in the form of global coordinates from a construction site data model, with said global coordinates from the construction site data module, for example in the sense of a partially automated process routine being able to be provided to the crane operator or a crane fitter on a display to be able to be input in the anti-collision device checked and optionally corrected form or by acknowledgment. Alternatively, the provision of said data anti-collision device can also take place in a fully automated manner if the anti-collision device can communicate with a construction site processor via a data communication device and/or directly with a server on which the construction site data model is stored.

In a further development of the invention, the crane orientation can also be automatically provided in the form of an indication of direction in the global coordinate system from said construction site data model, for example in the form of the direction that faces from the respective crane center toward the center of another crane or of another construction site point.

Even though the crane position and/or the crane orientation is/are determined or provided with the aid of the satellite navigation and/or from the construction site data model in the form of global coordinates, the anti-collision device itself can then work in a local coordinate system in work operation. For this purpose, for example, the distances of two or three cranes relative from one another can be determined from the respective global coordinates of the centers of said two or three cranes. If the crane orientation has been indicated or provided in the form of a direction in the global coordinate system, a slewing gear sensor that detects the rotational position of the around about the upright axis can be correspondingly calibrated so that the anti-collision device can then work with the local signal of the slewing gear sensor. The anti-collision device and/or a transformation module connected thereto can automatically carry out the corresponding conversion of the global coordinates into a respective crane distance and/or into a respective crane orientation as soon as said data have been provided in the described manner.

To the extent that redundancy is desired or demanded on the installation of the anti-collision device, the crane position and/or the crane orientation can be respectively determined or provided in different manners, for example in that the crane position Is both determined by the satellite navigation module and is provided from the construction site data model. Alternatively or additionally, the crane orientation can be determined both by an electric compass and by the described detection of the crane positions by the satellite navigation module on the rotation of the crane.

### BRIEF DESCRIPTION OF THE DRAWINGS

The invention will be explained in more detail in the following with reference to a preferred embodiment and to associated drawings. There are shown in the drawings:

FIG. 1: a perspective representation of a crane in the form of a revolving tower crane that for installing its anti-collision device is provided with a satellite navigation module that is attached to the counterboom spaced apart from the crane axis of rotation; and

FIG. 2: a view of the measurement values of the satellite navigation module on a rotation of the crane about its upright crane axis of rotation.

### DETAILED DESCRIPTION

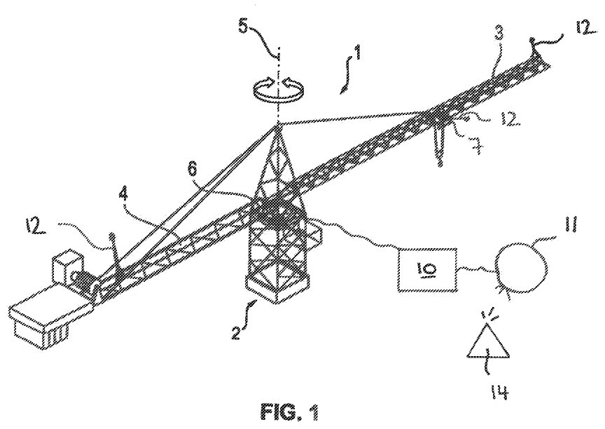

As FIG. 1 shows, the crane can be formed as a revolving tower crane 1, for example in the form of a so-called top-slewer whose tower 2 supports a boom 3 and a counterboom 4 which extend substantially horizontally and which are rotatable about the upright tower axis 5 relative to the tower 2. Instead of the crane configuration shown in FIG. 1, the revolving tower crane 1 could, however, also be formed as a bottom-slewer and/or could comprise a luffable fly boom and/or could be guyed via a guying to the tower bottom or to the superstructure, with the crane, however, also being able to be formed as a telescopic crane having a luffable boom or as a transfer harbor crane.

To be able to rotate the boom 3, a slewing gear 6 is provided which is provided in the embodiment shown at the upper end of the tower 2 between the boom 3 and the tower 2 and which can comprise a sprocket with which a drive wheel driven by a drive motor 7 meshes.

A trolley 7 can be travelably supported at said boom 3, with said trolley 7 being able to be traveled via a trolley drive, The hoist rope to which a lifting hook 8 is attached or reeved runs over said trolley 7. The lifting hook 8 can be lowered and raised via a hoisting gear 9.

Said crane movements are controlled by a control device 10 of the crane 1 that controls and/or monitors said drives, in particular the slewing gear 6, the trolley drive, and the hoisting gear 9.

An electronic anti-collision device 11 is furthermore provided that can be connected to said control device 10 or can optionally also be formed hereby or can be implemented therein. Said anti-collision device 11 can also form a higher ranking module that can communicate with control devices of further cranes that are set up at the same construction site.

If crane movements result or are impending that may lead to collisions, said anti-collision device 11 can intervene in the respective control device 10 to stop the corresponding crane movement, in particular to stop the slewing gear 6 and/or the hoisting gear 9 and/or the trolley drive. Alternatively or additionally, a corresponding warning signal can also be displayed to the crane operator on a display.

To install said anti-collision device 11, the crane position, in particular the position of the crane axis of rotation 5, is determined with the aid of a satellite navigation module 12 that can be installed spaced apart from said crane axis of rotation 5 at the boom 3 or at the counterboom 4.

Since the satellite navigation module 12 per se can only determine a position in the form of global coordinates and cannot determine an orientation, the crane 1 is rotated about its upright crane axis of rotation 5 on the installation of the anti-collision system 1 so that the satellite navigation module 12 is traveled along a circular path around the crane axis of rotation 5.

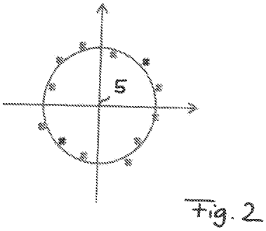

The positions measured on the rotation of the crane 1 about the crane axis of rotation 5 are shown in FIG. 2 and at least approximately reproduce the circular path of the satellite navigation module 12 about the crane axis of rotation 5.

The crane center or the position of the crane axis of rotation 5 can be determined by determining the center of the circular path that the satellite navigation module 12 has covered. The orientation of the crane can, for example, be calculated by taking over the northernmost circle point. In addition to geometrical processes, suitable statistical or optimization processes can also be used as calculation methods such as in particular the method of least squares.

The installation of the anti-collision system can advantageously hereby take place with the aid of only one satellite navigation module 12 and the required hardware can be minimized despite the automated installation.

Alternatively or additionally, the crane position and orientation can, however, also be determined in a different manner for reasons of redundancy. For example, two satellite navigation modules can be used that can be attached spaced apart from one another at the boom 3 and/or at the counterboom 4 and/or at the tower 2, on the one hand, and at the counterboom 4 or the boom 3, on the other hand.

In an advantageous further development of the invention, a satellite navigation module 12 can also be attached to said trolley 7 to be able to determine the orientation of the boom 3 in a simple manner by traveling the trolley 7 along the boom 3 and the positions measured in so doing. For this purpose, the slewing gear 6 is stopped and the trolley drive is actuated so that the positions measured by the satellite navigation module 12 lie at least approximately along a straight line that can, for example, be placed through the measurement points by a statistical evaluation method. Said straight line then corresponds to the orientation of the crane boom 3.

It can generally also be considered to attach the satellite receiver 12 to the crane hook and to evaluate the positions measured in this respect in a corresponding manner to determine the position or the orientation of the crane.

The crane position and/or the crane orientation can furthermore also be provided to the anti-collision device 11 in the form of global coordinate systems and/or a direction in the global coordinate system by input at a display or at an input device, with said global coordinates that reproduce the crane position and/or the global direction that reproduces the crane orientation being provided from a construction site data model 13. Said construction site model 13 can, for example, be stored in a server such as a master computer, with the provision to the anti-collision system being able to take place, for example, via a construction site master computer 14 and corresponding data links.

We claim:

1. A method of installing an anti-collision device of a crane that has a boom rotatable about an upright crane axis of rotation, the method comprising:
determining a crane position and an orientation of the boom;
automatically determining the crane position by a satellite navigation module at the crane;
providing the crane position to an anti-collision device in the form of global coordinates; and
automatically determining the orientation of the crane by an orientation sensor system attached to the crane;
providing the orientation of the crane to the anti-collision device in the form of a direction in the global coordinate system.

2. The method of claim 1, further comprising:
determining the orientation of the crane by the satellite navigation module, and wherein the satellite navigation module is attached to the crane spaced apart from the crane axis of rotation;
rotating the crane about its crane axis of rotation for the orientation determination;
determining the location of the crane axis of rotation from the positions of the satellite navigation module measured during the rotation of the crane;
determining the orientation of the crane by the orientation sensor system from the respective location of the satellite navigation module relative to the determined crane axis of rotation.

3. The method of claim 2, further comprising:
determining a circular path from the measurement points of the satellite navigation module on the rotation of the crane;
determining the center of the circular path as the crane axis of rotation;
evaluating said measurement points of the satellite navigation module by a geometrical evaluation method and/or a statistical evaluation method comprising the least square method.

4. The method of claim 1, further comprising:
determining the orientation of the crane with two or more satellite navigation modules attached spaced apart from one another to the boom and/or to the counterboom and/or to a tower on the one hand and to the boom or the counterboom on the other hand;
determining the orientation of the crane as a connection line between the measurement points of the plurality of satellite navigation modules spaced apart from one another.

5. The method of claim 1, further comprising:
determining the orientation of the crane with the aid of a satellite navigation module attached to a trolley of the crane;
traveling the trolley along the boom with a stopped slewing gear of the crane and with a straight line used as the orientation of the crane being determined by the positions of the satellite navigation module measured on the rotation of the trolley.

6. A method of installing an anti-collision device of a crane that has a boom rotatable about an upright crane axis of rotation, the method comprising:
providing the crane position and/or the orientation of the crane to an anti-collision device pneumatically in the form of global coordinates and/or of a direction in the global coordinate system from a construction site data model.

7. A crane having a boom rotatable about an upright crane axis of rotation and from which a lifting hook can be lowered, comprising:
a control device for controlling crane movements;
an anti-collision device for monitoring the crane movements for possible collisions and for disabling such crane movements and/or for outputting a warning signal,
a satellite navigation module to determine the crane position; and
an orientation sensor system to determine a crane orientation in the form of a direction in the global coordinate system;
wherein the anti-collision device is configured to use the crane position determined by the satellite navigation module in the form of global coordinates and to use the orientation of the crane determined by the orientation sensor system for collision monitoring.

8. The crane of claim 7, wherein the satellite navigation module is attached spaced apart from the crane axis of rotation to the boom, to a counterboom, and/or to a trolley travelable along the boom, wherein the orientation sensor system is configured to determine the orientation of the crane from a plurality of measurement points of the satellite navigation module determined on the rotation of the crane about the crane axis of rotation and/or on the traveling of the trolley.
